(19) United States
(12) Patent Application Publication
(10) Pub. No.: US 2010/0046813 A1
(43) Pub. Date: Feb. 25, 2010

(54) Systems and Methods of Analyzing Two Dimensional Gels

(76) Inventors: Keiji Takamoto, Shaker Heights, OH (US); Mark Chance, Moreland Hills, OH (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/376,051

(22) PCT Filed: Jul. 31, 2007
(86) PCT No.: PCT/US07/74836

§ 371 Date: Oct. 30, 2009

Related U.S. Application Data
(60) Provisional application No. 60/834,450, filed on Jul. 31, 2006.

(51) Int. Cl. G06K 9/68; G06T 7/00

(52) U.S. Cl. 382/128; 382/218; 382/190

(57) ABSTRACT

Systems and methods of analyzing two dimensional gels are provided, in one embodiment, a method is provided for analyzing a 2-dimensiαnal gel. The method comprises receiving a first image of a gel based on a first protein sample labeled with a first fluorophore, receiving a second image of the gel based on a second protein sample labeled with a second fluorophore, applying linear normalization to image intensity values of the second image to provide a linear normalized image, and comparing image intensity values of the linear normalized image from image intensity values of the first image to provide a compared image.

### RELATED APPLICATION

This application claims priority from U.S. Provisional Application No. 60/834,450) filed Jul. 31, 2006, the subject matter, which is incorporated herein by reference.

### FIELD OF THE INVENTION

The present invention relates to proteomics, and particularly relates to systems and methods of analyzing two dimensional gels.

### BACKGROUND

Proteomics analysis is an important technology for biomedical research in the post-genomics era. Expression proteomics, which explores the changes in protein expression levels, is one of the most important aspects of proteomics research. The importance of these technologies is to understand the fundamental biology of development and disease as well as discover biomarkers for ascertaining disease diagnosis and prognosis. There are a number of well established technologies for quantitative analysis of proteomes; these include 2-dimensional differential in gel electrophoresis (2D-DIGE) with quantification by fluorescence analysis of labeled proteins and “shotgun” proteomics methods by where quantification is performed using differential isotopic labeling of digested protein samples. The 2D-DIGE method of separation and quantification at the protein level is termed “top-down” proteomics, since the quantification is carried out at the intact protein level, while initial digestion followed by separation and quantification at the peptide level is termed a “bottom-up” approach. Both these experimental designs rely on the relative quantification of proteins within a control versus an experimental sample.

One conventional 2D-DIGE (differential in gel electrophoresis) technology solves the problem of comparison, represented by the analysis of two independent gels, by running the two samples with different fluorescent labeling, but in the same gel. Now the proteins, one from experiment and another from control, are detected in the same location in the gel by detection of the distinct emission wavelengths of the fluorophores. In order to achieve the goals of accurately detecting the expression level changes, a reliable and quantitative method for protein spot identification and quantification is of great importance. Currently, there are many commercial software products to perform this task, however, substantially all of them have inherent problems due to limitations in their basic methodology for spot detection and quantification. In addition, they are not capable of “discovering” unique spots in the gel that may be present due to spot overlap.

### SUMMARY OF THE INVENTION

In one aspect of the invention, a method is provided for analyzing a 2-dimensional gel. The method comprises receiving a first image of a gel based on a first protein sample labeled with a first fluorophore receiving a second image of the gel based on a second protein sample labeled with a second fluorophore, applying linear normalization to image intensity values of the second image to provide a linear normalized image, and comparing image intensity values of the linear normalized image from image intensity values of the first image to provide a compared image.

In another aspect of the invention, a computer readable medium is provided that has computer executable instructions for performing a method comprising receiving a first image of a 2-D differential gel based on a first protein sample labeled with a first fluorophore, receiving a second image of the 2-D differential gel based on a second protein sample labeled with a second fluorophore and applying linear normalization to image intensity values of the second image based on the first image to provide a linear normalized image. The method further comprises performing a pixel by pixel subtraction of image intensity values of the linear normalized image and image intensity values of the first image to provide a differential image, determining a second numerical derivative on image intensity values of the differential image to determine protein spot centers, and performing a non-linear fitting on image intensity values of the differential image based on the determined protein spot centers to determine spot intensity volumes of protein spots on the differential image.

In yet another aspect of the invention, a system is provided for analyzing a 2-dimensional get. The system comprises an image normalization and compare module that applies linear normalization to one of a first image of a gel based on a first protein sample labeled with a first fluorophore and a second image of the gel based on a second protein sample labeled with a second fluorophore based on the other of the first and second image. The image and normalization and compare component generates a compared image that is a comparison of a normalized one of the first image and second image to a non-normalized one of the first image and second image. The system further comprises a spot detection and fitting module that performs a non-linear fitting on image intensity values of the compared image based on determined protein spot centers to determine spot intensity volumes of protein spots on the compared image.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 illustrates a block diagram of a 2-dimensional differential in gel electrophoresis (2D-DIGE) analysis system in accordance with an aspect of the present invention.

FIG. 2 illustrates a differential image and a ratio image in accordance with an aspect of the present invention.

FIG. 3 is a set of images that illustrate derivation of a differential image in accordance with an aspect of the invention.

FIG. 4 is a set of images that illustrate the mitigation of steaks in the images as a result of the linear normalization and subtraction process in accordance with an aspect of the invention.

FIG. 5 is a set of images that illustrate the locating of low abundance proteins (that are changing in control vs. experimental) as a result of the linear normalization and subtraction process in accordance with an aspect of the invention.

FIG. 6 is a set of images that illustrate the locating of spot centers employing second derivatives of the differential image data in accordance with an aspect of the invention.

FIG. 7 is a set of images that illustrate spot fitting employing a skewed 2-D Gaussian parametric mathematical model in accordance with an aspect of the invention.

FIG. 8 illustrates a graph of two overlapping spots with the X-axis representing the X position of the image and the Y-axis representing intensity value of the image in accordance with an aspect of the present invention.

FIG. 9 illustrates a set of images that illustrate a modified second derivative image and a third derivative image with detected spot edges in accordance with an aspect of the present invention.

FIG. 10 illustrates a first image that illustrates globally matched Landmark spots and locally paired spots and a second image that illustrates locally matched spots with examination of angles and distances to judge the pairing in accordance with an aspect of the present invention.

FIG. 11 illustrates a methodology for analyzing a 2-dimensional differential gel in accordance with an aspect of the present invention.

FIG. 12 illustrates a methodology for spot detecting and spot fitting in accordance with an aspect of the invention.

FIG. 13 illustrates a computer system that can be employed to implement systems and methods in accordance with one or more aspects of the invention.

### DETAILED DESCRIPTION

The present invention relates to systems and methods of enhancing qualitative and quantitative analysis of two dimensional gels. The present invention provides for significant improvements in both protein spot detection and protein spot quantification.

It is to be appreciated that 2D-gel images are scanned by Image Scanners by fluorescent dye emissions from labeled samples. The samples can contain 2 or 3 samples of different origin, labeled with different fluorophores such as Cy2, Cy3 and Cy5. The scanned image for each fluorophore can be saved as 16 bit TIFF images. For example a sample from normal tissue may be labeled by Cy3, a sample from a disease tissue by Cy5, and both samples mixed together, and run in the same gel. This methodology retains the same proteins for both images in substantially the same location, which can be scanned independently. In this example, the scanner can produce two images, one scanned by Cy3 and another by Cy5.

As the same proteins migrate in the same places, a substantially complete match of the two images in terms of spot locations can be provided. The two images are “very similar” except that some proteins are increased in normal sample and others decreased. If we subtract these 2 images, we will see the “difference” between two images. As we are just interested in what is changing in expression proteomics, this gives the information desired. On the other hand, a simple subtraction does not work since there are many factors that affect the background level and intensities between images.

In one aspect of the invention, both images are scanned within a linear range of the scanner with one image normalized by linear transformation to the other. By this linear transformation and subtraction of pixels in the image, a differential image can be produced. This differential image has a number of attractive properties for further data analyses. For example, the background level is almost zero, the increases and decreases in protein levels can be visualized in an intuitive way, and the image complexity can significantly reduced, since protein spots that do not change are cancelled out and do not exist in the differential image.

As a result of virtually zero background intensities, it is possible to detect the (changing) spots with low intensities (e.g., low abundance proteins) that could not be detected by current state-of-the-art software packages. Another advantage is that spots that are hidden within the large, high intensity spots can be easily detected (if they are changing). This process also removes “streaks” that are frequently observed in the gel. This is yet another advantage as commercial software often assigns a series of “spots” incorrectly in the case of such typical gel imperfections.

Although differential image is sensitive to expression level changes and detection of small spots, overlapped spots, a ratio image can be more intuitive to observe the expression level changes of spots. The ratio image is a pixel by pixel log ratio comparison between the normalized image and the non-normalized image. The differential image indicates absolute change in intensities. However, a large change in intensity does not necessarily mean a large change in expression level. A high intensity spots may have small change in ratio but may have large change in volume. On the other hand, low intensity spots would have large change in intensities but absolute value of change could be small. The ratio image is an image of intensity change ratio thus, it is relative values and it does not reflect the absolute intensity changes. Thus, intensity ratio value at the center of spots represents expression level change rather than absolute volume change.

As mass spectrometers improve with increased dynamic range and good sensitivity, spots that show multiple proteins in “single” spots are commonly observed. It is, however, virtually impossible to tell which protein is changing or the relative abundance of proteins from mass spectrometry alone. This can be easily solved by the present invention as we can directly observe the “spot within the spot” and know precisely where each spot is located on the gel. The low complexity of images generated also guarantees better spot detection by minimizing background and spot overlapping problems.

The inherent problems associated with 2D-gel spot quantification include accuracy of spot detection and also accuracy of quantification. The spot quantification problem is maximal in the case of overlap. If spots are completely resolved, there is no major problem. If spots are heavily overlapped, not only spot detection is difficult but also quantification is extremely arbitrary and unreliable. This is because most commercial algorithms use a “boundary drawing” algorithm and draw arbitrary boundaries (with mathematical constraints) around the spots. In the case of overlapping spots, it is virtually impossible to draw correct boundaries around the spots and, therefore, the algorithm divides the spots at some relatively arbitrary place. This cannot be avoided with this type of quantification methods.

In another aspect of the present invention, the spots in 2D-gel can be represented by a parametric mathematical model, such as a 2D-Gaussian. The spot fitting by appropriate 2D peak functions that match well with actual spot intensity distribution produce highly accurate quantification results. This method also does not have spot boundary problems, as it does not draw any boundaries. As long as spots are correctly detected, they can be fitted accurately by this technique. In yet another aspect of the invention, a methodology is provided for determining initial parameters of the parametric mathematical models to facilitate appropriate convergence.

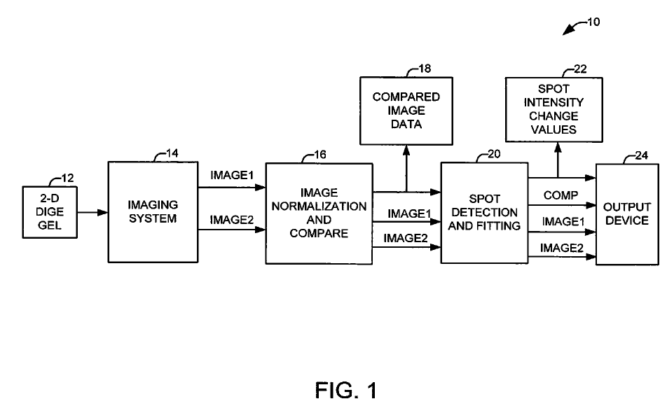

FIG. 1 illustrates a 2-D DIGE analysis system 10 in accordance with an aspect of the present invention. The system 10 includes an imaging system 14 that captures a first image (IMAGE1) of a 2-D DIGE gel 12 at a first laser excitation wavelength and captures a second image (IMAGE2) of the 2-D DIGE gel 12 at a second laser excitation wavelengths The 2-D DIGE gel 12 includes a first protein sample labeled With a first fluorophore (e.g., Cy3) and a second protein sample labeled with a second fluorphore (e.g., Cy5). The first protein sample can be, for example a normal protein sample, and the second protein sample can be, for example, a protein sample from a patient with a known disease. The first Image and the second image are then provided to an image normalization and compare module 16. The first and second Damages can be in the form of 16 bit TIFF images having approximately 4 million bits: with each bit having an intensity value that ranges from 0 to 65,536.

The image normalization and compare module 16 applies linear normalization on one of the first and second images. For example, linear interpolation is performed by employing X Intensity values for the first image and Y intensity values for the second images to determine coefficients m and b for the linear equation Y=mX+b. The second image can then be normalized relative to the first image by replacing each Y intensity value of the second image with a normalized X value based on the equation X=Y−B/m. It is to be appreciated that the normalization can be improved by removing pixels with large intensity value changes between the two images and maximizing the number of pixels in which Y approximately equal to X.

The image normalization and compare module 16 then compares the normalized second image intensity values with the original first image intensity values to produce compared image data 18. The image normalization and compare module 16 can produce the compared image data by subtracting normalized second image intensity values from the original first image intensity values to produce differential image data. The image normalization and compare module 16 can produce the compared image data 18 by determining a log ratio between normalized second image intensity values and the original first image intensity values (or visa versa) to produce ratio image data. The compared image data 18 can be employed to produce an image that illustrates changes in intensity values representing changes in protein levels either in a positive or negative direction. The image normalization and compare module 16 can produce both differential image data and ratio image data that can be utilized to provide both a differential image and a ratio image.

In another aspect of the invention, individual image areas or grid areas can be linear normalized differently, such that linear interpolation and linear normalization is applied individually to each selected area or grid. A user may select the number of individual areas (e.g., 4, 16, 64, 256, etc.) that are to be individually linear normalized. It is believed that the background level intensity can be reduced to less than one intensity value count by applying individually linear normalization to selected areas.

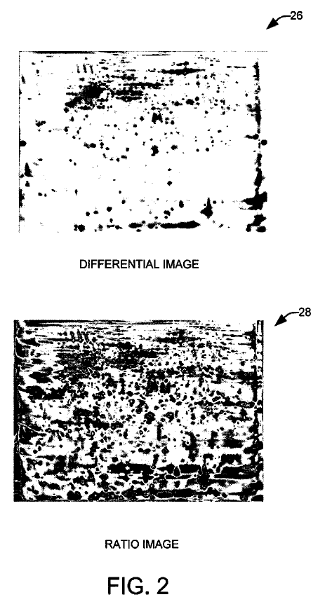

FIG. 2 illustrates a differential image 26 and a ratio image 28 in accordance with an aspect of the present invention. In the differential image 26 and the ratio image 28 darker spots (e.g., blue spots) indicate a decrease in protein levels, while lighter spots (e.g., red spots) indicate an increase in protein level. The differential image 26 can be determined by pixel by pixel intensity value subtraction between a normalized image in one channel (e.g. normal sample in Cy5 channel) and an original non-normalized image in another channel (e.g. diseased sample in Cy3 channel). The differential image is sensitive to expression level changes and detection of small spots and overlapped spots, and indicates absolute change in intensities. A large change in spot volume between the original non-normalized image and normalized image does not necessarily mean a large change in expression level. The high intensity spots may have small change in ratio but may have large change in volume. On the other hand, low intensity spots would have large ratio change in intensities but absolute value of change could be small The ratio image 28 is an image of intensity change ratio thus:, it is relative values and it does not reflect the absolute intensity changes. Thus, an intensity ratio value at the center of spots can represent expression level change rather than absolute volume change.

A ratio image can be determined by comparing the original non-normalized image to the normalized image based on a pixel by pixel comparison of the logarithmic ratio of the intensity values of associate pixels based on the following:

$${log}_{2} [ \frac{{A}_{2 i}}{{A}_{1 i}} ] \qquad EQ . 1$$

where A₁ᵢ and A₂ᵢ are the associated pixel intensity amplitudes of a given pixel for the normalized image in one channel and the other image in another channel, respectively.

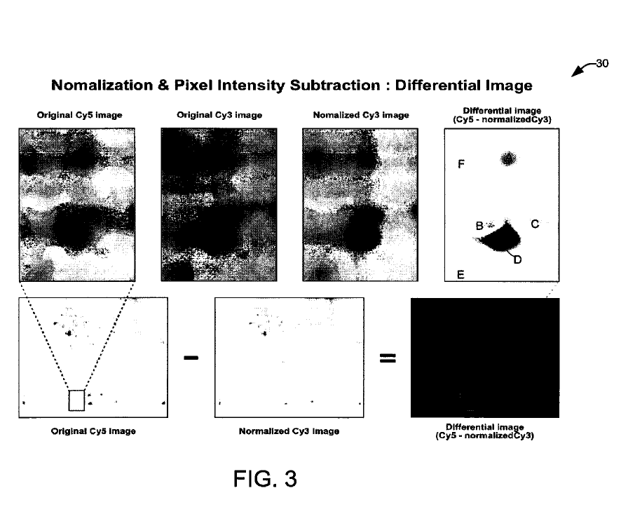

Although, the following examples, will be illustrated With respect to employment of a differential image, it is to be appreciated that a ratio image as discussed above can be employed in place of or in addition to the differential image data. FIG. 3 illustrates a set of images 30 that illustrate the derivation of the differential image. A top row illustrates a blown up version of a portion of the images illustrated as a box in the bottom row. The bottom row illustrates an original Cy5 image (normal tissue)−a normalized Cy3 image (disease tissue)=differential image (Cy5-normalizedCy3). The top row includes a portion of an original Cy5 image (normal tissue), a portion of an original Cy3 image, a portion of a normalized Cy3 image, and a portion of the differential image (Cy5-normalizedCy3). As illustrated in the differential image, protein levels that have changed remain. Although not shown, spots A, B and C have protein levels that have decreased, and spots D, E and F have protein levels that have increased, which can be indicated by different colors (e.g., red, blue).

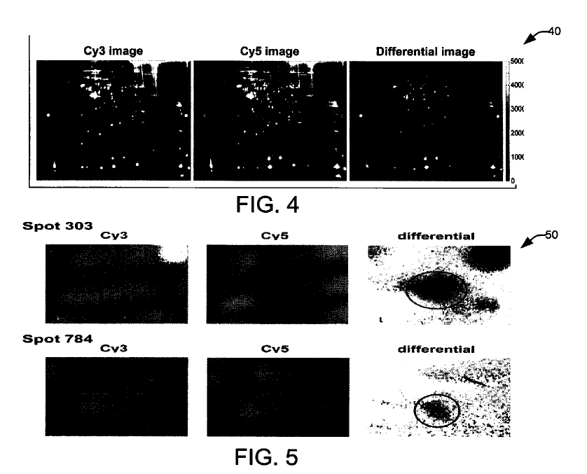

As previously stated the above linear normalization and subtraction process mitigates streaks in the original images, since the streaks are substantially cancelled due to the linear normalization and subtraction, as illustrated in the set of images 40 of FIG. 4. The linear normalization process reduces the background intensity within the gel from 500-600 illumination counts to about 10 illumination counts per pixel by removing the noise in the image of the background. Additionally, the above linear normalization and subtraction process facilitates the locating of low abundance proteins that are changing as illustrated in the set of images 50 of FIG. 5. This is an advantage over conventional systems that interpret low abundance proteins as regions within the gel having no observed change, since the background image substantially hides the low abundance proteins in the gel. Furthermore, spots that are hidden within high intensity spots can be readily detected if they are changing. These spots would be hidden by the high intensity spots in a conventional system.

Referring again to FIG. 1, the first image, the second image and the compared image data 18 are provided to a spot detecting and fitting module 20. The spot detecting and fitting module 20 determines the centers of each spot by finding the maximum intensity inflection point. This can be accomplished by performing a first numerical derivative and a second numerical derivative of the compared image and multiplying the second numerical derivative values with the compared image values. The first numerical derivative is determined by determining difference intensity values between adjacent pixels across adjacent rows and columns, which is then repeated for the second numerical derivative based on the first numerical derivative.

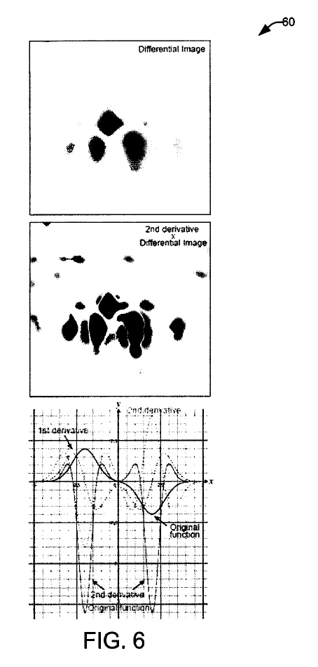

FIG. 6 is a set of images 60 that illustrate the locating of spot centers employing second derivatives of the differential image data. The set: of images 60 show image displays of a differential image and its second derivative where the X axis represents position along the X axis of the image and Y represents intensity value (Z axis of image not shown). FIG. 6 also illustrates a plot of values representing the second derivative times the differential image intensity value. The spot detecting and fitting module 20 analyzes these values to identify local minima that have a negative numerical value. These represent true local maximum or minimum, or inflection points within the differential image to indicate a spot center. This overall method detects spots that cannot be seen in the original image that are overlapping.

The spot detecting and fitting module 20 then performs a non-linear fitting to the differential image to determine spot volumes. In one aspect of the present invention, the spot detecting and fitting module applies a skewed 2-D Gaussian parametric mathematical model to spots to determine spot intensity volume employing the above determined spot centers to define the number of spots and associated terms in the skewed 2-D Gaussian parametric mathematical module. The skewed 2-D Gaussian parametric mathematical module is also applied to either the first or second image to determine the original spot intensity volumes. The following spot density functions can be employed to apply the skewed 2-D Gaussian parametric mathematical modeling:

$$\begin{matrix}γ = A \cdot {e}^{- f ( x , z )} [ \begin{matrix}X \\ Z\end{matrix} ] = [ \begin{matrix}cos θ & sin θ \\ - sin θ & cos θ\end{matrix} ] [ \begin{matrix}x - {x}_{c} \\ z - {z}_{c}\end{matrix} ] & EQ . 2 \\ f ( x , z ) = \{ \begin{matrix}\frac{1}{sk {1}_{x}} {( \frac{X}{{w}_{x}} )}^{4} + \\ sk {2}_{x} {( \frac{X}{{w}_{s}} )}^{3} + \\ sk {1}_{x} {( \frac{X}{{w}_{x}} )}^{2}\end{matrix} \} + \{ \begin{matrix}\frac{1}{sk {1}_{z}} {( \frac{Z}{{w}_{z}} )}^{4} + \\ sk {2}_{z} {( \frac{Z}{{w}_{z}} )}^{3} + \\ sk {1}_{z} {( \frac{Z}{{w}_{z}} )}^{2}\end{matrix} \} & EQ . 3\end{matrix}$$

where x is column position, z is row position, x_{c} and z_{c} is spot center, θ is the spot rotation, wₓ and w_{z} is spot width and sk1ₓ, sk2ₓ, sk1_{z} and sk2_{z} are skewness parameters.

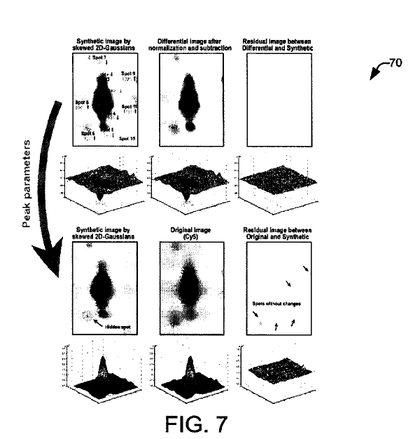

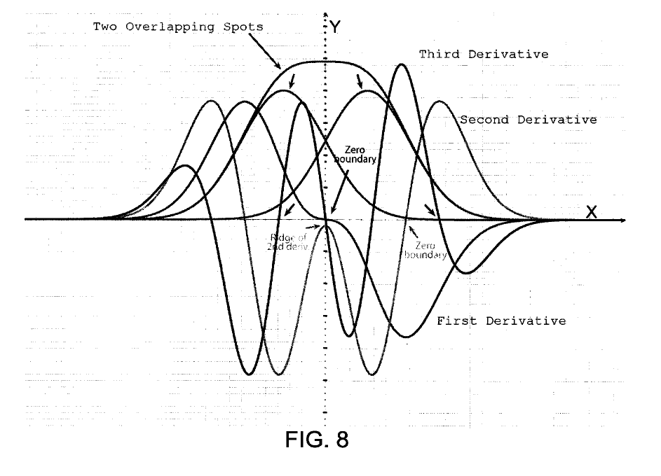

Spot volume intensity changes 22 can be determined by comparing the spot intensity volumes of the differential image with the spot intensity volumes of either the first or second image. FIG. 7 illustrates a set of images 70 that provide a top row that is a comparison of a synthetic image produced by non-linear fitting with a skewed 2-D Gaussian versus a differential image and a residual image between the differential and synthetic that represents the error with the non-linear fitting. A bottom row illustrates a synthetic image produced by non-linear fitting with a skewed 2-D Gaussian versus and an original image and a residual image between the original and synthetic that illustrates spot volume and changes in spot volume. As illustrated in FIG. 1, the spot intensity volume change values 22, the compared image data 18, the first image and the second image can then be provided to an output device 24, such as a display, a printer or some other form of output for analysis.

In another aspect of the invention a methodology is provided to determine initial parameters for the skewed 2-D Gaussian parametric mathematical model to facilitate appropriate convergence. The initial parameter can be, for example, spot center x_{c} and z_{c}, spot width wₓ and w_{z} and spot center amplitude A. As previously stated, the spot detecting and fitting module 20 calculates the modified second derivative image as follows:

Modified second derivative=(second derivative)×(differential image) EQ. 4

As differential image contains both positive and negative values, the spot center information within second derivative image may be both positive and negative. Also, in order to emphasize the degree of change and also sign of intensity values, the second derivative is multiplied by image intensity values of the differential image. In this way, all local minima in second derivative are guaranteed to be negative values. This makes spot center detection easier and also prevent detection of false-positive spots (such as dent in the curvature of spot density distributions). Spot detection can be done with simply finding a local minimum value in negative value range to determine spot center x_{c} and z_{c} and spot center amplitude A. The second derivative also determined spot zero boundaries which can be employed to determine spot width wₓ and w_{z}.

The initial parameters can be determined based on the following analysis. A Simplified Spot Density Function (just oval shape) can be described based on EQ. 5 below:

$$f ( x , z ) = A \cdot e \text{?} \\ \text{?} \text{indicates text missing or illegible when filed} \qquad EQ . 5$$

where x is column position, z is row position, x_{c} and z_{c} is spot center, wₓ and w_{z} is spot width and A is spot amplitude.

1st partial derivatives of EQ. 5 are shown in EQ. 6 and EQ. 7

$$\begin{matrix}\frac{δ f}{δ x} = - 2 A \frac{x - x \text{?}}{w \text{?}} \cdot e \text{?} & EQ . 6 \\ \frac{δ f}{δ z} = - 2 A \frac{z - z \text{?}}{w \text{?}} \cdot e \text{?} \\ \text{?} \text{indicates text missing or illegible when filed} & EQ . 7\end{matrix}$$

2nd partial derivatives of EQ. 5 are shown in EQ. 8, EQ. 9 and EQ. 10

$$\begin{matrix}\frac{{δ}^{2} f}{δ x \text{?}} = \frac{4 A}{w \text{?}} \{ {( \frac{x - x \text{?}}{w \text{?}} )}^{2} - \frac{1}{2} \} \cdot e \text{?} & EQ . 8 \\ \frac{{δ}^{2} f}{δ z \text{?}} = \frac{4 A}{w \text{?}} \{ {( \frac{z - z \text{?}}{w \text{?}} )}^{2} - \frac{1}{2} \} \cdot e \text{?} & EQ . 9 \\ \frac{{δ}^{2} f}{δ x δ z} = \frac{{δ}^{2} f}{δ z δ x} = \frac{4 A}{w \text{?}} ( x - x \text{?} ) ( z - z \text{?} ) \cdot e \text{?} \\ \text{?} \text{indicates text missing or illegible when filed} & EQ . 10\end{matrix}$$

For the calculation of derivatives for a given pixel, a sum of these derivatives is used.

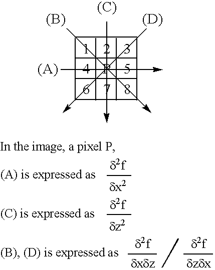

F−(A)+(B)+(C)+(D) EQ. 11

For actual numerical derivative calculations A=(Intensity of pixel P−Intensity of pixel 4)+(intensity of Pixel P−intensity of pixel 5), B=(intensity of pixel P−Intensity of pixel 8)+(intensity of Pixel P−intensity of pixel 1), C=(Intensity of pixel P−Intensity of pixel 7)+(Intensity of Pixel P−intensity of pixel 2) and D=(intensity of pixel P−Intensity of pixel 6)+(Intensity of Pixel P−intensity of pixel 3),

Based on the above, image F can be expressed as follow:

$$F = \frac{{δ}^{2} f}{δ {x}^{2}} + \frac{{δ}^{2} f}{δ {z}^{2}} + \frac{{δ}^{2} f}{δ x δ z} + \frac{{δ}^{2} f}{δ z δ x} \qquad EQ . 12$$

Here, (B), (D) are symmetric along z-axis thus, (X−X_{c}) is opposite direction Thus, if (B) is expressed as

$$\frac{{δ}^{2} f}{δ z δ x} ,$$

then (D) is

$$\frac{{δ}^{2} f}{δ z δ ( - x )} = - \frac{{δ}^{2} f}{δ z δ x} ∴ F = \frac{{δ}^{2} f}{δ {x}^{2}} + \frac{{δ}^{2} f}{δ {z}^{2}}$$

Thus, the “summed” 2^{nd} derivative for spot detection is

$$\begin{matrix}∴ F = \frac{{δ}^{2} f}{δ {x}^{2}} + \frac{{δ}^{2} f}{δ {z}^{2}} & EQ . 13 \\ = 4 A [ \begin{matrix}\frac{1}{w \text{?}} \{ ( \frac{x - x \text{?}}{w \text{?}} ) \text{?} - \frac{1}{2} \} + \\ \frac{1}{w \text{?}} \{ ( \frac{z - z \text{?}}{w \text{?}} ) \text{?} - \frac{1}{2} \}\end{matrix} ] e \text{?} \\ \text{?} \text{indicates text missing or illegible when filed} & EQ . 14\end{matrix}$$

At F=0,

$$F = \frac{{δ}^{2} f}{δ {x}^{2}} = \frac{4 A}{w \text{?}} \{ ( \frac{x - x \text{?}}{w \text{?}} ) \text{?} - \frac{1}{2} \} e \text{?} = 0 \\ ∴ ( \text{?} ) \text{?} = \frac{1}{2} \\ \text{?} \text{indicates text missing or illegible when filed}$$

Define rₓ=x−x_{c} as Wₓ, W_{z}>0 Same way,

$${r}_{s} = \frac{w \text{?}}{\sqrt{2}} ∵ \text{?} = \sqrt{2} {r}_{x} {w}_{z} = \sqrt{2} r \text{?}$$

$$\text{?} \text{indicates text missing or illegible when filed}$$

at the spot center, x=x_{c}, z=z_{c}

$$\begin{matrix}\begin{matrix}F = 4 A [ \frac{1}{w \text{?}} \{ - \frac{1}{2} \} + \frac{1}{w \text{?}} \{ - \frac{1}{2} \} ] e \text{?} \\ = - 2 A [ \frac{1}{w \text{?}} + \frac{1}{w \text{?}} ]\end{matrix} & EQ . 15 \\ F = - 2 A \frac{w \text{?} + w \text{?}}{w \text{?} w \text{?}} A = - \frac{1}{2} F \frac{w \text{?} - w \text{?}}{w \text{?} + w \text{?}} \\ \text{?} \text{indicates text missing or illegible when filed} & EQ . 16\end{matrix}$$

As ω [symbol] =\sqrt{2}rₓ and ω [symbol] =\sqrt{2}r

[symbol]

$$F = - 2 A \frac{w \text{?} + w \text{?}}{w \text{?} \text{?} w \text{?}} \\ \text{?} \text{indicates text missing or illegible when filed} \qquad EQ . 17$$

As x_{c}, z_{c} are already known, all unknown parameters can be calculated from observed values

$$w \text{?} = \sqrt{2} {r}_{x} \\ w \text{?} = \sqrt{2} r \text{?} \\ A = - \frac{1}{2} F \frac{w \text{?} \text{?} w \text{?}}{w \text{?} + w \text{?}} \\ \text{?} \text{indicates text missing or illegible when filed} \qquad EQ . 18$$

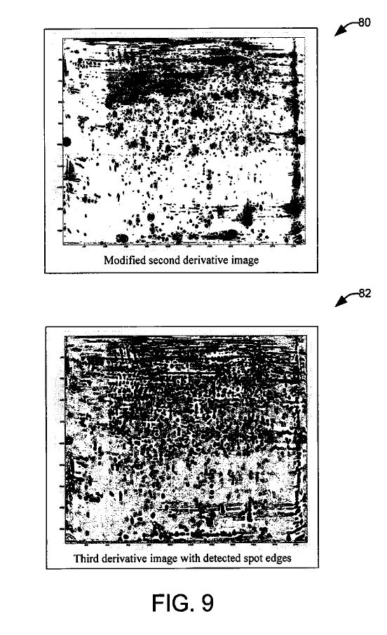

After spot centers, spot widths and spot amplitudes are detected in second derivative image and filtered, a third derivative image is calculated for the spot parameter estimation for overlapping spots. Third derivative image provides spot edges and is used for detecting the spot width information and separation of two closely located spots by calculating slope change in the second derivative. FIG. 8 illustrates a graph of two overlapping spots with the X-axis representing the X position of the image and the Y-axis representing intensity value of the image (Z-axis of image not shown). In the case of heavily overlapping spots, a second derivative does not give zero-boundary information as the ridge of the second derivative does not reach the zero intensity value. The zero valued position in the third derivative indicates the watershed in the second derivative and thus the spot edge between the two overlapping spots. FIG. 9 illustrates a set of images that illustrate a modified second derivative image 72 and a third derivative image 74 with detected spot edges.

It is to be appreciated that detected spots in different gel images need to be matched in order for further processing such as statistical analyses. In accordance with another aspect of the invention, a spot matching process is provided for the global matching based on the pattern recognition with directions and distances among “Landmark” spots without human intervention such as spots that need to be assigned by a researcher. The landmark spots are chosen with the following criteria: well resolved; separated from each other; not too intense; or too faint. The candidate spots are tentatively paired between sets of detected spots from two images (different gels for replication). This pairing process or done with the following methodology.

Initially spots are marked with the angle and distance from a Left Top of image. This is an Acidic/High molecular weight direction. This is chosen because in 2-D gel, acidic pH range has better reproducibility among the experiments and high molecular weight region also shows smaller variation in mobility. These “angles and distances” are compared between two sets of detected spots and “similar” spots within the sets are tentatively paired as potential landmark spots. These spots are marked with angles and distances among them for each set. The candidate pair is judged by total and ratio of matching with the other candidate spots. If the spots match the criteria, they go next step otherwise they are rejected. All detected spots within the vicinity of a candidate landmark spots are marked with the angles and distances from the candidate spot. These spots are then subjected to local matching check in order to confirm or reject whether pairing is correct or not.

As a global check eliminate “obviously wrong” candidate pair, it is difficult to eliminate the pairs that are wrong but close enough to be judged by a global check. These local spots are then compared between two sets for candidate spots. If the spots match the criteria (total number of matching, percentage matching etc), these two spots are determined as landmark spots. After landmark spots are determined and pairing is done, a vector field is calculated for landmark spots and nearby “local” spots that are paired in previous steps. This Vector field is used to interpolate the vectors for other spots that have not yet been paired.

The interpolation process is performed using the following principle. The electrophoresis physical processes and spot locations within the image change gradually between two images. There is no “crossing” vector among any spots, nor “sharp turn” of vectors. Additionally, the length of vector changes is gradual. The newly paired spots are checked by local matching again in order to make sure they are correctly matched. At the end of the process, an overall vector field is examined for its smoothness in both length and angles. If there are vectors that do not satisfy criteria, local matching processes are repeated until all criteria are satisfied,

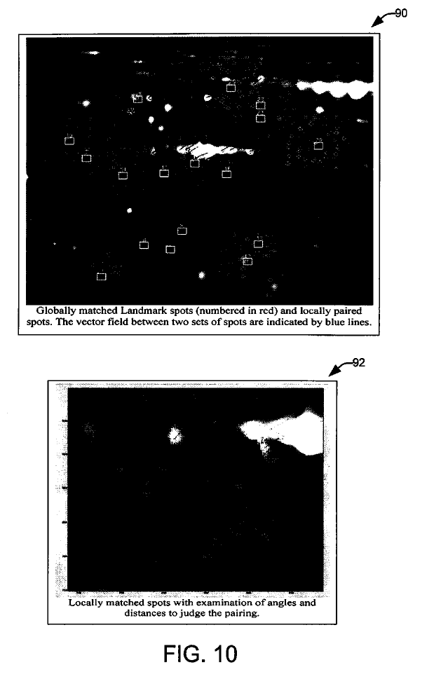

FIG. 10 illustrates a first image 90 that illustrates globally matched Landmark spots enclosed in squares and locally paired spots. The vector field between two sets of spots is indicated by dark lines. FIG. 10 also illustrates a second image 92 that illustrates locally matched spots with examination of angles and distances to judge the pairing.

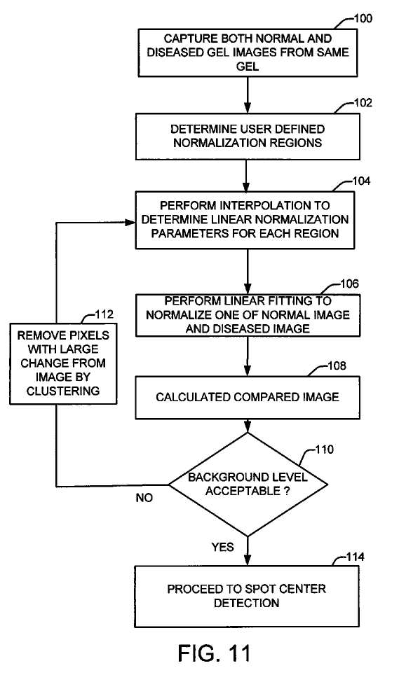

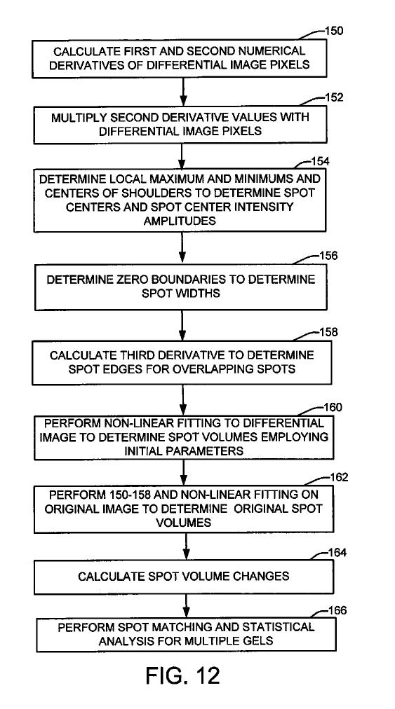

In view of the foregoing structural and functional features described above, the methodologies will be better appreciated with reference to FIGS. 11-12. It is to be understood and appreciated that the illustrated actions, in other embodiments, may occur in different orders and/or concurrently With other actions. Moreover not all illustrated features may be required to implement a method. It is to be further understood that the following methodologies can be implemented in hardware (e.g., a computer or a computer network as one or more integrated circuits or circuit boards containing one or more microprocessors), software (e.g. as executable Instructions running on one or more processors of a computer system), or any combination thereof.

FIG. 11 illustrates a methodology for analyzing a 2-dimensional differential gel in accordance with an aspect of the present invention. At 100, an image from a sample containing normal proteins and an image from a sample containing proteins from the diseased sample are received. The normal and diseased gel images may come from a same gel but are labeled with different fluorophores associated with different protein samples. At 102 user defined normalization regions are determined. For example, a user may specify a single region for normalization (i.e., the entire gel image) or multiple regions (e.g., 4, 16, 64, 256) for applying different normalizations to each region. At 104, linear interpolation is performed to determine linear normalization parameters for each region. At 106, linear fitting is performed to normalize one of the normal image and the diseased image, as previously described with respect to FIG. 1. At 108, compared intensity values are calculated by comparing the normalized image with the image that is not normalized. The comparison may be determined by performing a pixel by pixel subtraction or a pixel by pixel logarithmic ratio of the normalized image pixel intensity values with the non-normalized image pixel intensity values. The methodology then proceeds to 110.

At 110, a determination is made to determine if the background level is acceptable. If the background level is not acceptable (NO), the methodology proceeds to 112 to remove pixels with large changes from the image to be normalized, and then proceeds to 104 to repeat the linear interpolation. If the background level is acceptable (YES), the methodology proceeds to 114 to proceed to spot detection.

FIG. 12 illustrates a methodology for spot detecting and spot fitting in accordance with an aspect of the present invention. At 150, first and second numerical derivatives of a differential image pixel intensity values are determined. At 152, the second derivative differential image pixel intensity values are multiplied by the differential image pixel intensity values to provide a modified differential image. At 154, local maximums, minimums, or inflection points are determined for the modified differential image to establish centers of spots, spot amplitudes in addition to centers of overlapping spots and overlapping spot amplitudes within the modified differential image. At 156, zero boundaries of the spots are determined to determine spot widths within the modified differential image. At 158, a third derivative is calculated to determine spot edges for overlapping spots. The methodology then proceeds to 160.

At 160, non-linear fitting is performed on the modified differential image to determine spot volumes, such as a skewed 2-D Gaussian parametric model to determine spot volumes on the modified differential image employing the initial parameters determined at 154, 156 and 158. At 162, 150-158 are repeated on the original image and non-linear fitting is performed on the original image to determine spot volumes. The non-linear fitting can be performed on either the normal or diseased image, and can be, for example, a skewed 2-D Gaussian parametric model. At 164, spot volume changes are calculated by comparing the original non-linear fitted spot volumes to the modified differential non-linear fitted spot volumes. At 166, spot matching and statistical analysis is performed on multiple gals in which the methodologies of FIGS. 11-12 have been performed.

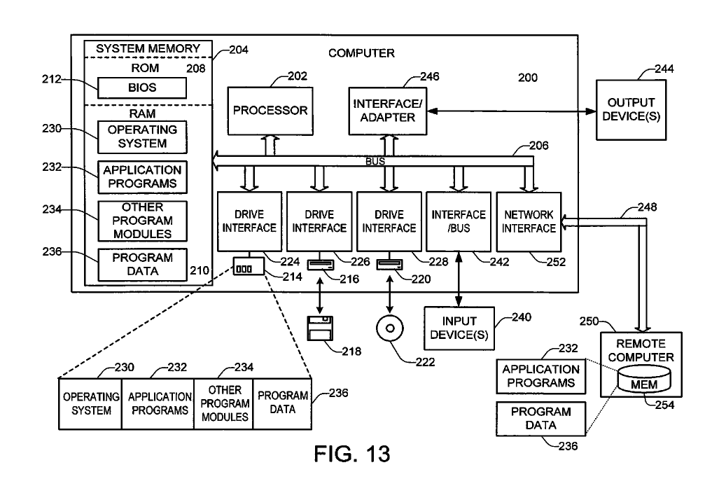

FIG. 13 illustrates a computer system 200 that can be employed to implement systems and methods described herein, such as based on computer executable instructions running on the computer system. The computer system 200 can be implemented on one or more general purpose networked computer systems, embedded computer systems, routers, switches, server devices, client devices, various intermediate devices/nodes and/or stand alone computer systems. Additionally, the computer system 200 can be implemented as part of the computer-aided engineering (CAE) tool running computer executable instructions to perform a method as described herein.

The computer system 200 includes a processor 202 and a system memory 204. A system bus 206 couples various system components, including the system memory 204 to the processor 202. Dual microprocessors and other multi-processor architectures can also be utilized as the processor 202. The system, bus 206 can be implemented as any of several types of bus structures, including a memory bus or memory controller, a peripheral bus, and a local bus using any of a variety of bus architectures. The system memory 204 includes read only memory (ROM) 208 and random access memory (RAM) 210. A basic input/output system (BIOS) 212 can reside in the ROM 208, generally containing the basic routines that help to transfer information between elements within the computer system 200, such as a reset or power-up.

The computer system 200 can include a hard disk drive 214, a magnetic disk drive 216, e.g., to read from or write to a removable disk 218, and an optical disk drive 220, e.g., for reading a CD-ROM or DVD disk 222 or to read from or write to other optical media. The hard disk drive 214, magnetic disk drive 216, and optical disk drive 220 are connected to the system bus 206 by a hard disk drive interface 224, a magnetic disk drive interface 226, and an optical drive interface 228, respectively. The drives and their associated computer-readable media provide nonvolatile storage of data, data structures, and computer-executable instructions for the computer system 200. Although the description of computer-readable media above refers to a hard disk, a removable magnetic disk and a CD, other types of media which are readable by a computer, may also be used. For example, computer executable instructions for implementing systems and methods described herein may also be stored in magnetic cassettes, flash memory cards, digital video disks and the like.

A number of program modules may also be stored in one or more of the drives as well as in the RAM 210, including an operating system 230, one or more application programs 232, other program modules 234, and program data 236. The one or more application programs can include the system and methods of enhancing qualitative and quantitative analysis of two dimensional gels previously described in FIGS. 1-8.

A user may enter commands and information into the computer system 200 through user input device 240, such as a keyboard, a pointing device (e.g., a mouse). Other input devices may include a microphone, a joystick, a game pad, a scanner, a touch screen, or the like. These and other input devices are often connected to the processor 202 through a corresponding interface or bus 242 that is coupled to the system bus 206. Such input devices can alternatively be connected to the system bus 206 by other interfaces, such as a parallel port, a serial port or a universal serial bus (USB). One or more output device(s) 244, such as a visual display device or printer, can also be connected to the system bus 206 via an interface or adapter 246. The computer system 200 may operate in a networked environment using logical connections 248 to one or more remote computers 250. The remote computer 250 may be a workstation, a computer system, a router, a peer device or other common network node, and typically includes many or all of the elements described relative to the computer system 200. The logical connections 248 can include a local area network (LAN) and a wide area network (WAN).

When used in a LAN networking environment, the computer system 200 can be connected to a local network through a network interface 252. When used in a WAN networking environment, the computer system 200 can include a modem (not shown), or can be connected to a communications server via a LAN. In a networked environment, application programs 232 and program data 236 depicted relative to the computer system 200, or portions thereof, may be stored in memory 254 of the remote computer 250.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention the following is claimed:

1. A method for analyzing a 2-dimensional (2D) gel, the method comprising:
receiving a first image of a gel based on a first protein sample labeled with a first fluorophore;
receiving a second image of the gel based on a second protein sample labeled with a second fluorophore;
applying linear normalization to image intensity values of the second image based on the first image to provide a linear normalized image; and
comparing image intensity values of the linear normalized image with image intensity values of the first image to provide a compared image.

2. The method of claim 1, wherein the comparing image intensity values comprises performing a pixel by pixel Log ratio of image intensity values of the linear normalized image and image intensity values of the first image to provide a ratio image.

3. The method of claim 1, wherein the comparing image intensity values comprises performing a pixel by pixel subtraction of image intensity values of the linear normalized image and image intensity values of the first image to provide a differential image.

4. The method of claim 3, further comprising determining a second numerical derivative on image intensity values of the differential image to determine protein spot centers.

5. The method of claim 4, further comprising determining a third numerical derivative on image intensity values of the differential image to determine spot edges between overlapping protein spots.

6. The method of claim 4, further comprising performing a non-linear fitting on image intensity values of the differential image based on the determined protein spot centers to determine spot intensity volumes of protein spots on the differential image.

7. The method of claim 6, wherein the performing a nonlinear fitting on image intensity values of the differential image based on the determined protein spot centers comprises applying a skewed 2-D Gaussian parametric model on image intensity values of the differential image.

8. The method of claim 6, further comprising:
performing a second numerical derivative on image intensity values of one of tie first and second image to determine protein spot centers;
performing a nonlinear fitting on image intensity values of the one of the first and second image based on the determined protein spot centers to determine spot intensity volumes of protein spots on the one of the first and second image; and
determining spot intensity volume changes based on comparing the spot intensity volumes of the one of the first and second image and the differential image.

9. The method of claim 8, further performing a spot matching to match spots on the one of the first and second image with spots on the differential image and performing statistical analysis on the matched spots.

10. The method of claim 3, further comprising determining a second numerical derivative of the differential image and multiplying the differential image by the second numerical derivative to provide a modified differential image.

11. The method of claim 10, further comprising analyzing the modified differential image to determine initial parameter for performing a non-linear fitting on image intensity values of the modified differential image to determine spot intensity volumes of protein spots on the differential image.

12. The method of claim 11, wherein the initial parameters comprise spot centers, spot widths and spot amplitudes.

13. The method of claim 11, wherein the performing a non-linear fitting on image intensity values of the differential image based on the determined protein spot centers comprises applying a skewed 2-D Gaussian parametric model on image intensity values of the modified differential image employing the determined initial parameters.

14. The method of claim 1, wherein applying linear normalization to image intensity values of the second image to provide a linear normalized image comprises;
performing linear interpolation to determine coefficients of a linear equation; and
replacing intensity values of the second image with intensity values based on the linear equation.

15. The method of claim 14, wherein the performing linear interpolation and replacing intensity values is applied independently to different regions on the second image.

16. A computer readable medium having computer executable instructions for performing the method comprising:
receiving a first image of a 2-D differential gel based on a first protein sample labeled with a first fluorophore;
receiving a second image of the 2-D differential gel based on a second protein sample labeled with a second fluorophore;
applying linear normalization to image intensity values of the second image based on the first Image to provide a linear normalized image;
performing a pixel by pixel subtraction of image intensity values of the linear normalized image and image intensity values of the first image to provide a differential image;
determining a second numerical derivative on image intensity values of the differential image to determine protein spot centers; and
performing a non-linear fitting on image intensity values of the differential image based on the determined protein spot centers to determine spot intensity volumes of protein spots on the differential image.

17. The computer readable medium of claim 16, further comprising determining a third numerical derivative on image intensity values of the differential image to determine spot edges between overlapping protein spots.

18. The computer readable medium of claim 16, wherein the performing a non-linear fitting on image intensity values of the differential image based on the determined protein spot centers comprises applying a skewed 2-D Gaussian parametric model on image intensity values of the differential image.

19. The computer readable medium of claim 16, further comprising:
performing a second numerical derivative on image intensity values of one of the first and second image to determine protein spot centers;
performing a non-linear fitting on image intensity values of the one of the first and second image based on the determined protein spot centers to determine spot intensity volumes of protein spots on the one of the first and second image; and
determining spot intensity volume changes based on comparing the spot intensity volumes of the one of the first and second image and the differential image.

20. The computer readable medium of claim 19, further performing a spot matching to match spots on the one of the first and second image with spots on the differential image and performing statistical analysis on the matched spots.

21. The computer readable medium of claim 16, further comprising:
multiplying the differential image by the second numerical derivative to provide a modified differential image:
analyzing the modified differential image to determine initial parameters comprising at least one of spot centers, spot amplitudes and spot widths; and
performing a skewed 2-D Gaussian parametric model on image intensity vales of the modified differential image employing the determined initial parameters to determine spot volumes.

22. The computer readable medium of claim 16, wherein applying linear normalization to image intensity values of the second image to provide a linear normalized image comprises;
performing linear interpolation to determine coefficients of a linear equation; and
replacing intensity values of the second image with intensity values based on the linear equation, wherein the performing linear interpolation and replacing intensity values is applied independently to different regions on the second image.

23. A system for analyzing a 2-dimensional (2D) gel, the system comprising:
an image normalization and compare module that applies linear normalization to one of a first image of a gel based on a first protein sample labeled with a first fluorophore and a second image of the gel based on a second protein sample labeled with a second fluorophore based on the other of the first and second image and generates a compared image that is a comparison of a normalized one of the first image and second image to a non-normalized one of the first image and second image; and
a spot detection and fitting component that performs a non-linear fitting on image intensity values of the compared image based on determined protein spot centers to determine spot intensity volumes of protein spots on the compared image.

24. The system of claim 23, wherein the compared image is generated based on a pixel by pixel logarithmic ratio of image intensity values of the normalized one of the first image and second image and image intensity values of the non-normalized one of the first image and second image to provide a ratio image.

25. The system of claim 23, wherein the compared image is generated based on a pixel by pixel subtraction of image intensity values of the normalized one of the first image and second image and image intensity values of the non-normalized one of the first image and second image to provide a differential image.

26. The system of claim 23, wherein the non-linear fitting is a skewed 2-D Gaussian parametric model.

27. The system of claim 23, the spot detection and fitting component further determines a second numerical derivative on image intensity values of the compared image to determine initial parameter for the non-linear fitting, the initial parameters comprising protein spot centers, spot amplitudes and spot widths.

28. The system of claim 27, the spot detection and fitting component further determines a third numerical derivative on image intensity values of the compared image to determine spot edges between overlapping protein spots

29. The system of claim 23, the image normalization and compare module applies linear normalization independently to different regions on the normalized image.
